(19) United States
(12) Patent Application Publication
(10) Pub. No.: US 2013/0324166 A1
(43) Pub. Date: Dec. 5, 2013

(54) METHOD AND APPARATUS USING GEOFENCE TO TRACK INDIVIDUAL GROUP MEMBERS

(71) Applicants: Mubashir Mian, Santa Clara, CA (US); Rita H. Wouhaybi, Portland, OR (US); Stanley Mo, Portland, OR (US); Tobias Kohlenberg, Portland, OR (US)

(72) Inventors: Mubashir Mian, Santa Clara, CA (US); Rita H. Wouhaybi, Portland, OR (US); Stanley Mo, Portland, OR (US); Tobias Kohlenberg, Portland, OR (US)

(21) Appl. No.: 13/995,070

(22) PCT Filed: Dec. 30, 2011
(86) PCT No.: PCT/US11/68164

§ 371 Date: Jun. 17, 2013

(51) Int. Cl. H04W 4/02

(52) U.S. Cl. CPC H04W 4/021
USPC 455/457

(57) ABSTRACT

A method is provided to track geolocations of multiple mobile location tracking enabled devices, each such device associated with at least one member of a group of subjects; one of the devices sends a map image of a real-world location and indicia of geofence to each of the other devices; each of multiple devices sends its geolocation to at least one other device in the group; the at least one device in the group displays the respective geolocations of the other devices relative to the map image and relative to the geofence image; an alert is generated by the at least one other device in the group in response to a determination that at least one of the devices in the group is disposed outside the geofence or within a prescribed distance from the geofence.

### BACKGROUND

The widespread availability of mobile devices that support text messaging, voice communication and web-based applications has lead to these devices becoming an integral medium for dialogue during everyday activities. These mobile devices are easy to use and allow for immediate communication. Communication may be one-to-one or may be shared with a select group. Moreover, the location of the devices may be tracked with precision using technologies such as satellite positioning systems.

Location-based applications involving “geofences” have increased in popularity in recent years, along with an increased use of mobile devices and satellite positioning systems. The mobile device includes a position sensing receiver that is capable of providing the location of the device, and thus also provides the location of a subject such as a person, car or other physical asset carrying the device. A geofence defines a virtual boundary about a real-world geographic region for use with a location based service or application. A geofence is commonly used in conjunction with a mobile location tracking enabled device so that a notification may be generated when the device, and a user in possession of the device, crosses the geofence to enter or exit the geographic region. Such notification may be transmitted via a mobile telephone or an email or SMS message, for example.

More particularly, in operation a geofence defines a virtual boundary that distinguishes geolocations (e.g., latitude, longitude pairs) that are within a geofenced region from geolocations that are outside of the geofenced region. A location tracking enabled device periodically determines its location. The position sensing receiver includes a Global Positioning System (GPS) receiver that receives signals from various GPS satellites. As is understood in the art, a GPS receiver operates to provide location information to a relatively high degree of accuracy by performing well known trilateration algorithms based on signals from several GPS satellites. The determined geolocation of the mobile device is evaluated against the geolocations encompassed by the geofence to determine whether the mobile device is inside or outside of the geofenced region.

Establishing a geofence often involves use of a computer display screen and user interface (UI) tools to define a geofence relative to a map image of a physical geographic region that is associated with coordinates that correspond to latitude and longitude coordinates of a real-world region to be encompassed by the geofence. The map image may include physical features such as, for example, rivers, lakes, mountains, roads, homes, hotels, stores, office buildings, shopping malls, construction sites, parks and other landmarks and also may indicate non-physical information such as town boundaries and areas zoned for different uses. The UI tool typically is used to define geofence boundaries relative to these map features.

In general, a graphical user interface (UI) tool may be used to define a geofence. For example, one approach involves a UI tool in which a user selects point locations on the map that are to act as vertices of a polygonal shaped geofence. The UI tool automatically generates boundary segments that interconnect the selected points to thereby define a geofence that encloses a geographic region represented on the map. Another approach, for example, involves a UI tool to select an initial starting geofence location and shape such as a square or triangle or other regular polygonal shape, and then to manipulate active points on the polygon to change its shape by stretching or rotating different segments so as to define a customized geofence that encompasses the geographic region of interest. Another approach involves a user using a pointing device to draw a geofence about a region of the map display. In the case of a touch screen, the pointing device may be a user's finger. Still another approach involves a user selecting a reference point location on the map shown on a screen display, corresponding to a latitude and longitude, and then selecting a magnitude of a radius or major/minor axis depending upon the shape of the geofence; the tool automatically creates a geofence centered on the selected point location in order to create a boundary around the point feature. This approach has the advantage requiring a user to enter relatively little information, except the center location of the bounding box. The map locations of vertices or reference points may be stored in a computer readable storage device and may be sent over a network to a computing device for use to locally generate a geofence image to overlay a map display of the geographic region of interest.

Thus, a geofence may be established to create an electronic perimeter about virtually any real-world location, and mobile computing devices may provide both rich and instantaneous communications between persons at different locations and may continuously determine and report their own locations. Geofences have been used for tracking individuals for safety purposes, such as to keep track of children by determining when they have arrived at or departed from a secure location such as a school, for example. Mobile devices also have been used for safety purposes to provide for instantaneous communication while a person is on the move. GPS equipped mobile devices also have been used for safety purposes to track the whereabouts of teens while they are driving a car, for example.

Nevertheless there remains a need to use mobile device tracking and communication capability in concert with geofence surveillance capability to provide improved communication, and therefore, improved safety among individuals equipped with mobile location tracking enabled devices. The present invention meets this need.

### BRIEF DESCRIPTION OF THE DRAWINGS

Features and advantages of the embodiments herein will be apparent from the detailed description which follows, taken in conjunction with the accompanying drawings, which together illustrate, by way of example, features of the embodiments; and, wherein:

FIG. 1 is an illustrative drawing of an example map image and a geofence image produced on a screen display of a mobile location tracking enabled device in accordance with some embodiments.

FIG. 2 is an illustrative drawing of a process to send an invite to create a group whose members will be tracked using a geofence in accordance with some embodiments.

FIG. 3 is an illustrative flow diagram of a process to receive an invite to a group and to obtain personal information and location information to be shared among mobile devices of group members in accordance with some embodiments.

FIG. 4 is an illustrative flow diagram of a process to generate and share location information among mobile devices of group members in accordance with some embodiments.

FIG. 5 is an illustrative flow diagram showing additional details of a local position module of FIG. 4 in accordance with some embodiments.

FIG. 6 is an illustrative flow diagram of a process to respond to alerts sent by group members pursuant to the process of FIG. 5 in accordance with some embodiments.

FIG. 7 shows an example series of screen displays produced by a group member's mobile device.

FIG. 8 is an illustrative flow diagram of an example process control flow that corresponds to the screen displays of FIG. 7.

FIG. 9 provides an example illustration of a mobile device, such as a user equipment (UE), a mobile station (MS), a mobile wireless device, a mobile communication device, a tablet, a handset, or other type of mobile wireless device in accordance with some embodiments.

### DESCRIPTION OF THE EMBODIMENTS

The following description is presented to enable any person skilled in the art to create and use a system and method to permit a group of users equipped with mobile devices to use a geofence to keep track of each other within a real-world geographic region bounded by the geofence. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and processes are shown in block diagram form in order not to obscure the description of the invention with unnecessary detail. Thus, the present invention is not intended to be limited to the embodiments shown, but is to be accorded the widest scope consistent with the principles and features disclosed herein. In the following description, similar or substantially identical items shown in different drawings are labeled with identical reference numbers.

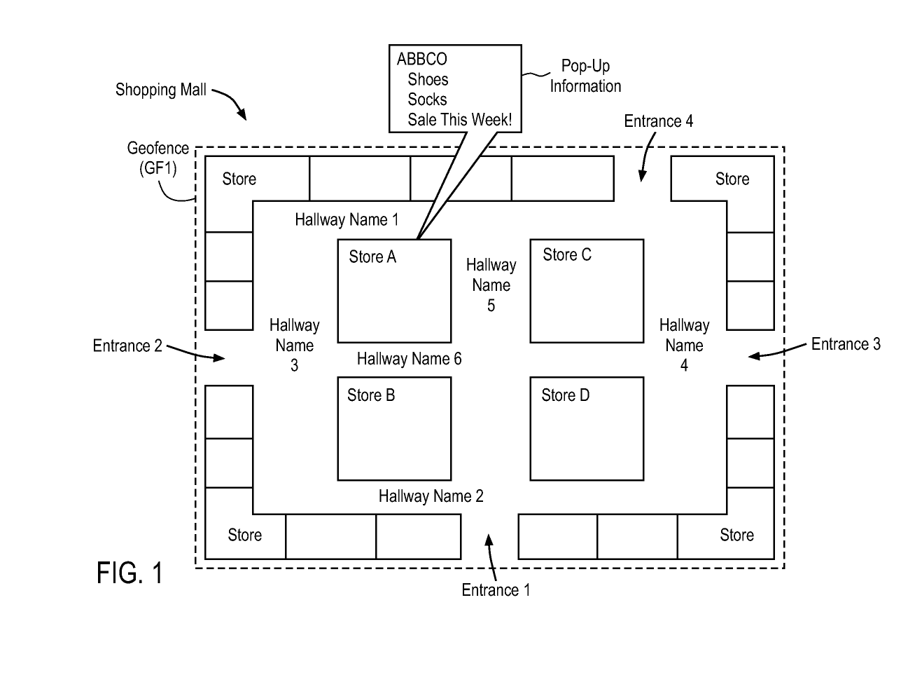

FIG. 1 is an illustrative drawing of an example map image and a geofence image produced on a screen display of a mobile location tracking enabled device such as a smartphone, tablet computer or any device that has display and may send/receive messages. The map in this illustrative example shows a shopping mall with pedestrian pathways (hallways) providing access to stores, restaurants and service areas inside. An image of the geofence GF1 on the display screen indicates that the geofence GF1 surrounds the entire mall. It will be appreciated, however, that tracking of individual group members does not necessarily require display of the geofence image, although the geofence image is useful to provide a visual cue to individual group members as to the geofence boundary. In this example, the map includes meta-information about locations encompassed by the geofence such as pop-up information concerning the names and departments within stores. A mobile device user interface includes a UI tool (e.g. point and click) to permit a user to obtain more detailed information about a particular location (e.g. a store) by using a UI tool to access the pop-up information by hovering a pointing device over a location for example. The meta-information also may include directions as to the shortest walkable path between certain locations and may include a calculation function for determining the distance along a path between two locations in a shopping mall, for example.

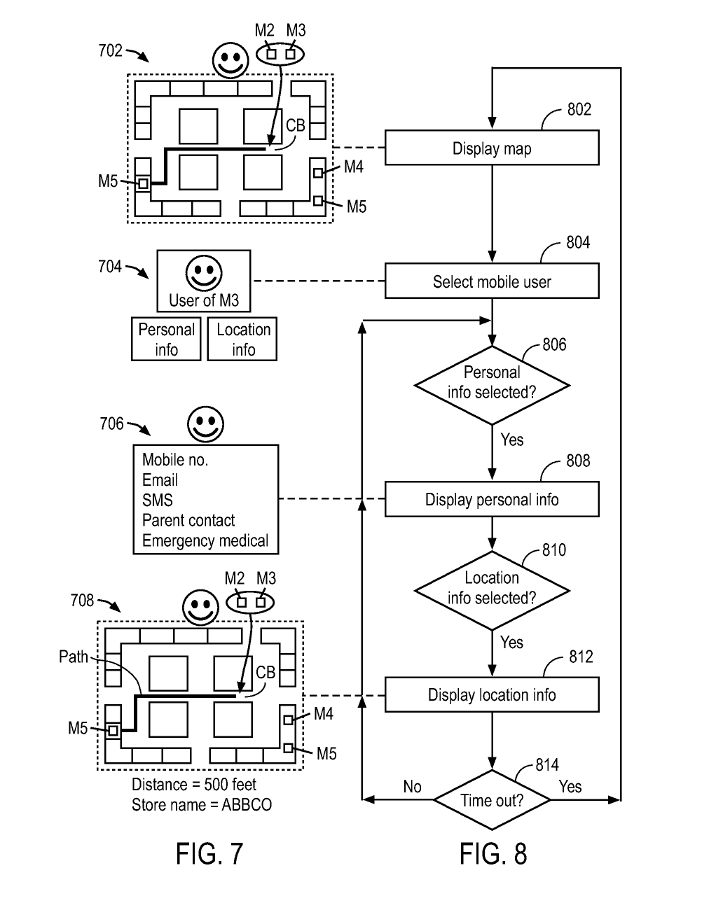

Consider the following scenario, which will be used to describe some embodiments. User of wireless mobile device M1 wants to create an ad hoc group G1 with the mobiles of users M2, M3 around him. User of creates an ad hoc group called Gr1. M1 determines its location. User of M1 creates/enables a geofence embodiment called GF1. User of M1 shares the GF1 with the ad hoc group Gr1. User of M1 enables a timer value of 4 hours for the ad hoc group session. Wireless mobile devices M2 and M3 of group members receive the invitation to join Gr1. The invitation indicates the GF1 and the timer value of 4 hours. Users of mobile devices M2 and M3 accept the invitation to join Gr1. As a result, M1, M2 and M3 are configured to monitor and provide and/or to receive alerts regarding proximity to GF1 for the 4 hour timer limit. During the time interval while the Gr1 is active, M1, M2 and M3 actively sends each other their location coordinates. During the time interval while the Gr1 is active, the users of mobile devices M1, M2 and M3 may ‘see’ each other on a geo map on the displays of M1, M2 and M3. Refer to FIGS. 7-8 which show mobile devices and geofence in the context of the shopping center mall example of FIG. 1.

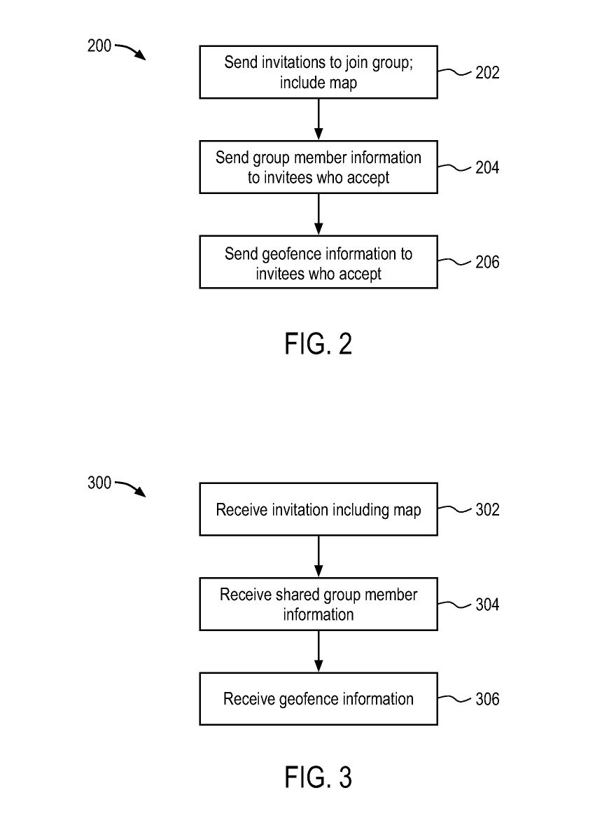

FIG. 2 is an illustrative flow diagram of a process 200 to create a group whose members will be tracked using a geofence in accordance with some embodiments. A mobile location tracking enabled device is configured with computer program instruction code to implement the modules shown within FIG. 2. More particularly, the mobile location tracking enabled device includes an article of manufacture including a machine readable storage device encoded to cause the mobile device to perform the process 200. In some embodiments the mobile device that implements the process 200 is a first mobile device M1 that is owned or controlled by a group leader. Process module 202 causes the group leader's mobile device M1 to send invitations to multiple mobile devices M2, M3 (and perhaps more) to join an ‘ad hoc geolocation group’ Gr1. The invitation sets forth a location and a time frame for the group and may include a list of invitees, e.g., Mt, M2, and M3. In some embodiments, the invitation includes a shared map of the real-world location to be visited by the group. More particularly, in some embodiments, the module 202 may provide a link to a web site from which the shared map may be downloaded. The time frame indicates the time during which group member locations will be tracked and during which a geofence will be used to determine whether individual group members have entered or exited the geofenced region. In addition the time frame will track that this ad hoc session will end for the members to track each other, and the members do not have to do anything themselves to end this session of tracking each other. The purpose of the group Gr1 may be to ensure safety of individual group members during an excursion to a geographic location such as a shopping mall by keeping track of individual group members' locations and determining whether any of them has exited the mall, for example. It will be appreciated that the master may extend the duration of the tracking and geofence if for example, a group member becomes lost or goes missing.

Process module 204 causes the group leader's mobile device M1 to send shared group member information to mobile devices of users who accepted the invitation to join the group. In some embodiments, the shared group member information includes device communication information for each group member's mobile device (M1, M2, M3) and also includes certain personal information about each group member. In some embodiments, the mobile device communication information identifies mobile device phone numbers and SMS (short message service) and/or MMS (multimedia messaging service) Email addresses could be used as alternative channels if the device cannot do phone calls and/or SMS/MMS. That may be used to communicate the location a group member's mobile device location and that may receive information concerning locations of all other group member mobile devices. In some embodiments, the group member personal information includes names, phone numbers, addresses, emergency contact information and photos so that group members may easily recognize, contact and assist one another. As explained more fully below, the shared group member information is supplemented with up to date location information generated for each group member during the scheduled group time frame.

Process module 206 causes the group leader's mobile device M1 to send information to mobile devices of users who accepted the invitation to implement the geofence GF1 on individual group members' mobile devices M1, M2, M3 and to produce the geofence GF1 and to produce a visual display of the geofence GF1 in registration with the map. The geofence information may include, for example, map locations of vertices and/or center point of a polygonal geofence that may be used to automatically generate the geofence relative to the map and relative to the real-world region represented by the map. It will be appreciated that a predefined geofence may be provided that demarcates a boundary about a real-world geographic region, such as a shopping mall, a school or a construction site for example. Alternatively, the group leader may use a UI tool to define a custom geofence relative to a geographic region of interest that is represented on the map.

FIG. 3 is an illustrative flow diagram of a process 300 to obtain personal information and location information to be shared among mobile devices of group members in accordance with some embodiments. Each invited group member's mobile device is configured with computer program instruction code to implement the modules shown within FIG. 3. More particularly, each invited group member's mobile device includes an article of manufacture including non-transitory storage device encoded to cause a the mobile device to perform the process 300. Process module 302 causes the group member's mobile (M2, M3) device to receive the map image information sent by the group leader's mobile device and to make the map image available for display on the mobile device display screen. Alternatively, the invitees may use their mobile devices M2, M3 to download the map from a web site, for example. Process module 304 causes the invited group member's mobile device to receive the shared group member information sent by the group leader's mobile device and to make that information viewable on the mobile device display screen. Process module 306 causes the invited group member's mobile device (M2, M3) to receive the geofence information sent by the group leader's mobile device M1 and to process the information to produce a geofence image for display in conjunction with the received map.

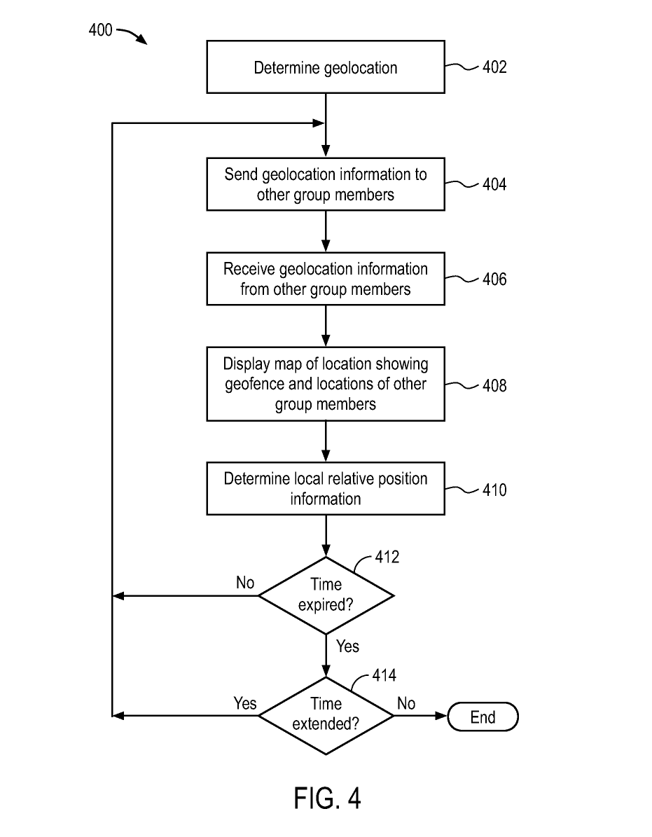

FIG. 4 is an illustrative flow diagram of a process 400 to generate and share location information among mobile devices of group members in accordance with some embodiments. Each invited group member's mobile device is configured with computer program instruction code to implement the modules shown within FIG. 4. More specifically, each invited group member's mobile device includes an article of manufacture including a non-transitory storage device encoded to cause a the mobile device to perform the process 400. Process module 402 causes the group member's mobile device to determine its location, specifically its latitude and longitude coordinates. In some embodiments, module 402 obtains information about a device's location from the device's own built-in GPS receiver. Module 404 sends information indicating the mobile device's location to the other mobile devices in the group. Conversely, module 406 receives information from each of the other mobile devices indicating their respective locations. The devices use data grams that may be in the form of messages that may carry geo-coordinates e.g. SMS/MMS messages, email messages or other similar message types, to exchange location information. Module 408 displays the shared map of the real-world location showing an image representing the geofence and showing the relative locations of each group member mobile device. Thus, each mobile device user may track his or her location and proximity to the geofence and also may track those of each of the other mobile devices users in the group.

Module 410, which is described in more detail below, configures the mobile device to generate position information relative to the geofence and relative to one or more other group members. Decision module 412 determines whether the time period defined for the ad hoc geolocation group has expired. If not, then control flows back to module 404. However, if the time has expired, then control flows to decision module 414, which determines whether the time has been extended. The group leader may extend the time, for example, if one of the group members is missing and needs to be located before ending the group. If time has been extended, then control flows to module 404. If time has not been extended, then the process 400 ends.

In some alternative embodiments, mobile devices in the group send geolocation information to the mobile device of the group leader and rather than to all other mobile devices in the group. In some alternative embodiments, there may be more than one group leader. Moreover, in some alternative embodiments, the mobile device of the one or more group leaders determine whether individual devices in the group are outside the geofence and determine whether individual devices of the group are within a prescribed distance from the geofence. In these alternative embodiments, displays of the one or more group leader devices display locations of the multiple devices of the group.

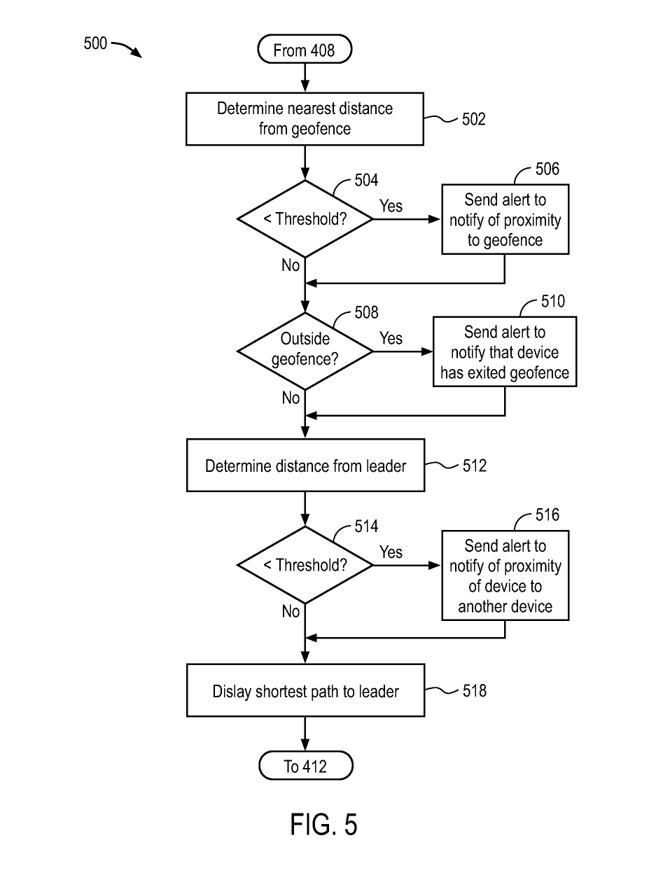

FIG. 5 is an illustrative flow diagram showing additional details of the local position module 410 of FIG. 4 in accordance with some embodiments. Each invited group member's mobile device is configured with computer program code to implement the modules shown within FIG. 4. Process module 502 causes the group member's mobile device to determine the closest distance to the geofence. Decision module 504 determines whether the distance from of the mobile device from the geofence is less than a first threshold distance. The first threshold distance, for example, is selected to alert the user that he is near the geofence established for this session and to avoid alerting others in the this geo tracking session he should exercise caution to not trigger an unnecessary alarm to the rest of the group and hence avoid anxiety. In some embodiments, the geofence is displayed on the device display screen preferably in color or dashed or dotted lines to provide the user with a visual cue to aid in avoiding the boundaries of the geo fence. If distance is less than the first threshold distance, then control flows to module 506, which sends an alert message to the group leader's mobile device to generate an alert as to the proximity of the user of the mobile device to the geofence. In some embodiments, the alert message is sent not only to the group leader's mobile but also to the mobile devices of others who are designated to assist in the management of the group. In still other embodiments, alert message is sent to the mobile devices of all members of the group. Control then flows to decision module 508. If decision module 504 determines that the distance is not less than the first threshold, then control flows directly to module 508.

Decision module 508 determines whether the mobile device is outside the geofence. If the mobile device is determined to be outside the geofence, then control flows to module 510, which sends an alert message to the group leader's mobile device to generate an alert that the user of the mobile device has exited the geofence. In some embodiments, the alert message also is sent to the mobile devices of others assisting in group management. In yet other embodiments, the alert message is sent to the mobile devices of all members of the group. Control then flows to decision module 512. If decision module 508 determines that the distance is not outside the geofenced region, then control flows directly to module 512.

Module 512 determines distance of the mobile device from the group leader. In some embodiments, the distance is determined based upon distances along designated paths shown within the map representing the real-world geographic region. Referring to the example of FIG. 1, those paths would be along the different hallways within the mall. In other embodiments, the distance determination is based upon a radial distance. Although a user's determining distance based on reference to a map is an alternative. The distances between map locations are determined based upon meta-data associated with the map itself. Decision module 514 determines whether the distance is within a second threshold distance from the group leader. If the distance from the leader is less than the second threshold, then control flows to module 516, which sends a message to the group leader's mobile device to provide an alert as to the close proximity of the mobile device user to the group leader. Control then flows to module 518. If decision module 514 determines that the distance is not less than the second threshold, then control flows directly to module 518.

Module 518 displays the shortest path from the group member's mobile device to the group leader. In some embodiments, the shortest path distance determined by module 512 is used to select a shortest path through the map from the group member to the group leader. The map may be associated a process to highlight the route to make it easier to follow.

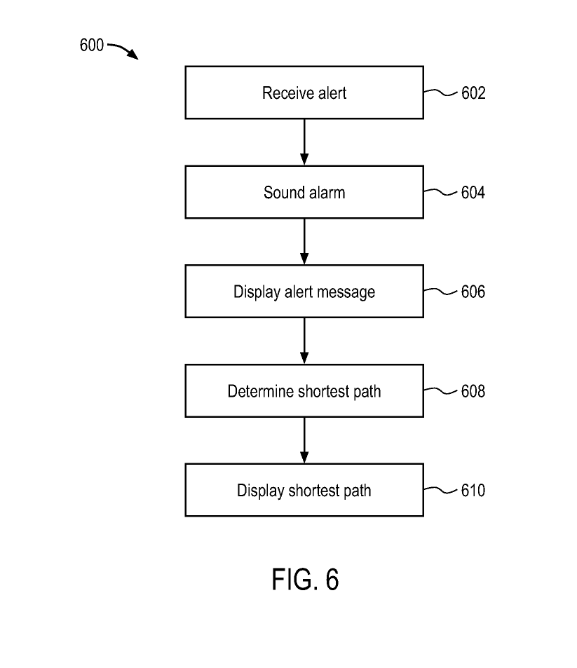

FIG. 6 is an illustrative flow diagram of a process 600 to respond to alert messages sent by group members pursuant to the process of FIG. 5 in accordance with some embodiments. The group leader's mobile device is configured with computer program instruction code to implement the modules shown within FIG. 6. In particular, particularly, the group leader's mobile device includes an article of manufacture including non-transitory storage device encoded to cause a the mobile device to perform the process 600. Process module 602 configures the mobile device to receive an alert message and to determine the type of alert—proximity to geofence, exited the geofence or proximity to the leader, for example. In response to the alert, module 604 causes the mobile device to generate an audible alarm. In response to the alert, module 606 causes the mobile device to display on its display screen a message that specifies the type of alert. Module EE 08 determines the shortest path between the leader's mobile device and the mobile device that sent the alert. The shortest path may be determined as explained above with reference to FIG. 5 based upon distances along designated paths shown within the map using meta-data associated with the map itself, or alternatively, based upon a radial distance calculation. Alternatively, the device sending the alert also may send an indication of the shortest path together with the alert. Module 610 displays the shortest path on the map on the group leader's mobile device display screen. The path may be using highlighted, for example.

FIG. 7 shows an example series of screen displays produced by a group member's mobile device. FIG. 8 is an illustrative flow diagram of an example process control flow 800 that corresponds to the screen displays of FIG. 7. Responsive to module 802, the screen display 702 shows a map of a mall and shows the locations of mobile device users M1 through M5. Assume for the purpose of this example that the screen displays and control flow are those of user device M1. At module 804, user M1 provides UI input to select an icon on screen 702 corresponding to user M2. In response, the user device M2 produces a screen display 704 containing an image of user of device M2 and a menu for selection of personal and/or location information concerning user of device M2.

Decision module 806 determines whether the user M1 selects the personal information menu item of screen 704. If the personal information menu item is selected then module 808 configures the device to display personal information concerning user M2 as shown in display screen 706. In this example, the personal information includes mobile phone number, email address, SMS (short message service) address, MMS (multimedia messaging service), address, parental contact information and emergency medical information. In some embodiments, the parental information and the emergency medical information may be made available only to the group leader and other specially designated group members. If the personal information menu item is not requested then decision module 810 determines whether the user M1 selects the location menu item of screen 704. If the location menu item is requested then module 812 configures the device to display location information concerning user M2 as shown in display screen 708. In this example, the location information includes the map showing a highlighted shortest path between users M1 and M2. The screen display also indicates that the distance along the path is 500 feet and that user M2 is located in a store named “ABBCO”. The store information may be provided as meta-data associated with the map itself.

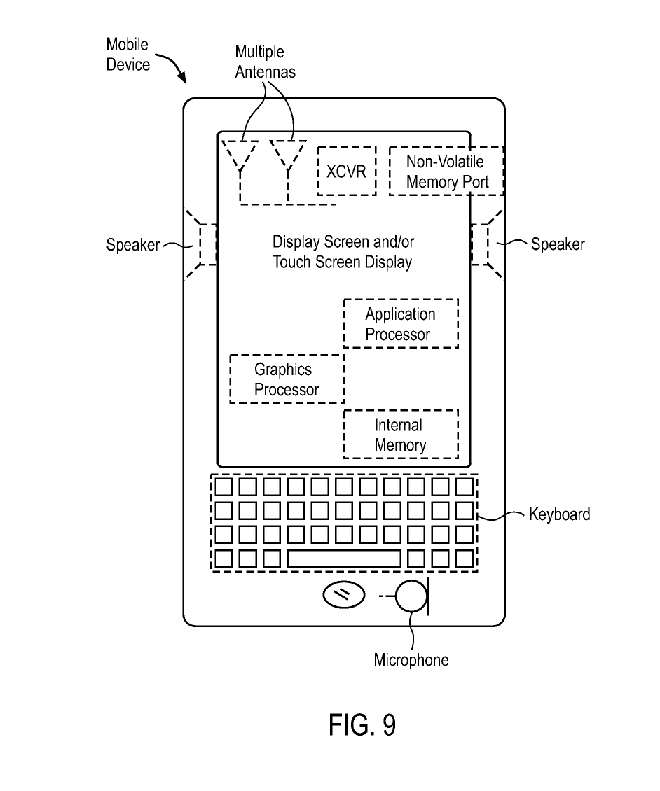

FIG. 9 provides an example illustration of a mobile device, such as a user equipment (UE), a mobile station (MS), a mobile wireless device, a mobile communication device, a tablet, a handset, or other type of mobile wireless device. The mobile device may include one or more antennas configured to communicate with a base station (BS), an evolved Node B (eNB), or other type of wireless wide area network (WWAN) access point. The mobile device may be configured to communicate using at least one wireless communication standard including 3GPP LTE, WiMAX, High Speed Packet Access (HSPA), Bluetooth, and WiFi. The mobile device may communicate using separate antennas for each wireless communication standard or shared antennas for multiple wireless communication standards. The mobile device may communicate in a wireless local area network (WLAN), a wireless personal area network (WPAN), and/or a wireless wide area network (WWAN).

FIG. 9 also provides an illustration of a microphone and one or more speakers that may be used for audio input and output from the mobile device. The display screen may be a liquid crystal display (LCD) screen, or other type of display screen such as a organic light emitting diode (OLED) display. The display screen may be configured as a touch screen. The touch screen may use capacitive, resistive, or another type of touch screen technology. An application processor and a graphics processor may be coupled to internal non-transitory storage device (storage memory) to provide processing and display capabilities. A non-volatile memory port may also be used to provide data input/output options to a user. The non-volatile memory port may also be used to expand the memory capabilities of the mobile device. A keyboard may be integrated with the mobile device or wirelessly connected to the mobile device to provide additional user input. A virtual keyboard may also be provided using the touch screen.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Various techniques, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

The foregoing description and drawings of embodiments in accordance with the present invention are merely illustrative of the principles of the invention. Therefore, it will be understood that various modifications may be made to the embodiments by those skilled in the art without departing from the spirit and scope of the invention, which is defined in the appended claims.

What is claimed is:

1. An apparatus using a geofence to track individual group members, comprising:
a first mobile communication device associated with a member of a group of subjects to be tracked via geolocation, the first mobile device including:
a geolocation determination circuit;
a communication circuit;
a display;
a user input;
a processor;
a memory circuit including instructions that when executed by the processor, cause the first mobile device to perform operations including:
receive information indicative of a geolocation of a second device associated with a member of the group of subjects to be tracked via geolocation;
display, using the display, a map image together with a geofence image that indicate a region of the map bounded by the geofence;
display the respective geolocations of the first mobile device and the second mobile device relative to the map image and relative to the geofence image;
generate or receive information indicative of the respective geolocations of the first and second mobile devices relative to the geofence; and
generate or receive an alert message in response to a determination that one or more of the first or second mobile devices is located outside the geofence or within a prescribed distance of the geofence.

2. The apparatus of claim 1, comprising a second location determination circuit located remotely from the first mobile device, the second location determination circuit configured to receive information indicative of the locations of one or more of the first and second mobile devices relative to the geofence, configured to determine that one or more of the first or second mobile devices is located outside the geofence or within a prescribed distance from the geofence, and configured to generate and transmit the alert message to at least one of the first or second mobile devices.

3. The apparatus of claim 2, further comprising the second mobile device, and wherein the second location determination circuit is included as a portion of the second mobile device.

4. The apparatus of claim 1, wherein the instructions comprise instructions that cause the first mobile device to generate the alert message in response to a determination that one or more of the first or second mobile devices is located outside the geofence or within a prescribed distance of the geofence.

5. A method to track geolocations of multiple mobile location tracking enabled devices, each such device associated with at least one member of a group of subjects, the method comprising:
sending from one of the devices indicia of a map image of a real-world location to each of the other devices;
sending indicia of geofence from the one of the devices to each of the other devices;
receiving by the at least one of the devices in the group from each of the other of the multiple devices indicia of their geolocations;
displaying by the at least one of the devices in the group the respective geolocations of the other devices relative to the map image and relative to the geofence image; and
generating an alert by the at least one of the devices in the group in response to a determination that at least one of the other devices of the group is disposed outside the geofence or within a prescribed distance from the geofence.

6. The method of claim 5,
wherein sending by each of the multiple devices to at least one device in the group indicia of its geolocation includes sending by each of the multiple devices indicia of its geolocation to each of the other of the multiple devices; and
wherein receiving by the at least one device in the group from each of the other of the multiple devices indicia of their geolocations includes receiving by each of the multiple devices indicia of the geolocations of each of the other of the multiple devices.
wherein displaying by the at least one device in the group the respective geolocations of the other devices relative to the map image and relative to the geofence image includes displaying by each device in the group the respective geolocations of the other devices relative to the map image and relative to the geofence image;

7. The method of claim 5 further including:
using said one of the devices to define a geofence relative to the map image.

8. The method of claim 5,
wherein the act of sending from one of the devices indicia of a map image of a real-world location to each of the other devices includes sending a link to web address that provides the map.

9. The method of claim 5,
wherein the act of sending indicia of geofence from one of the devices to each of the other devices involves including the geofence together with the map image.

10. The method of claim 5,
wherein the geofence is predetermined; and
wherein the act of sending indicia of the geofence from one of the devices to each of the other devices involves including the geofence together with the map image.

11. The method of claim 5,
wherein each respective device determines its own geolocation in terms of GPS coordinates.

12. The method of claim 5,
wherein sending by each of the multiple devices to at least one device in the group indicia of its geolocation involves periodically sending such indicia of its geolocation; and
wherein receiving by the at least one device in the group from each of the other of the multiple devices indicia of their geolocations involves periodically receiving such geolocation indicia from such other devices.

13. The method of claim 5 further including:
sending from the one of the devices communication information for each group mobile device of the group.

14. The method of claim 5 further including:
sending from the one of the devices communication information for each group mobile device of the group;
wherein the communication information includes one or more of address information suitable for use in SMS/MMS messages or email messages.

15. The method of claim 5 further including:
monitoring by each of the respective devices its respective location relative to at least one designated mobile device;
sending an alert message to the at least one designated mobile device by a device to at least one device in the group in response to a determination by such device that such device has come within a prescribed distance from the at least one designated mobile device.

16. The method of claim 5,
wherein at least one subject comprises a person.

17. The method of claim 5 further including:
monitoring by each of the respective devices its respective location relative to the geofence; and
sending an alert message by a device within the group to the at least one device in the group in response to a determination by the device sending the alert message that such device is disposed outside the geofence or is within a prescribed distance from the geofence;
wherein generating the alert is responsive to the alert message.

18. A method to track geolocations of multiple mobile location tracking enabled devices, each such device associated with at least one member of a group of subjects, the method comprising:
at a first mobile device associated with a member of the group, receiving:
information indicative of the geolocations of the multiple mobile devices associated with the members of the group; and
at the first mobile device, displaying:
a map image together with a geofence image that indicate a region of the map bounded by the geofence;
the respective geolocations of the multiple mobile devices relative to the map image and relative to the geofence image; and
generating an alert at the first mobile device in response to a determination that one or more of the multiple mobile devices is located outside the geofence or has come within a prescribed distance from the geofence.

19. The method of claim 18,
wherein receiving at a first mobile device includes periodically receiving information indicative of the geolocations of the multiple mobile devices associated with the members of the group.

20. The method of claim 18 further including:
receiving at a first mobile device an alert message from a device within the group indicating that the device sending the alert message is disposed outside the geofence or is within a prescribed distance from the geofence;
wherein generating the alert is responsive to the alert message.

21. An article of manufacture including computer readable storage device encoded with program instruction code to cause a mobile location tracking enabled device to perform a process that includes:
receiving an invitation to join a group;
receiving group member identifying information associated with other mobile location tracking enabled devices of other group members;
receiving geofence location identifying information;
determining geolocation of the device;
sending the determined geolocation information of the to the devices of the other group members identified in the group member identifying information;
receiving geolocation information from the devices of the other group members identified in the group member identifying information;
displaying on the device, geofence location of at least one of the devices of at least one other group member; and
sending a message to a device of at least one other group member in response to the wireless mobile device coming within a prescribed relative location of the geofence.

22. The article of claim 21 further including:
receiving an indication of a map representing a physical geographic region encompassed by the geofence.

23. The method of claim 21 further including:
determining a distance between the device and a device of at least one other group member.

24. The method of claim 21 further including:
determining a distance between the device and a device of at least one other group member; and
displaying on the device, an indication of the determined distance between the device and the device of at least one other group member.

25. The method of claim 21 further including:
determining a distance between the device and a device of at least one other group member; and
sending an indication of the determined distance to the device of the at least one other group member.
